(19) United States
(12) Patent Application Publication
(10) Pub. No.: US 2016/0374073 A1
(43) Pub. Date: Dec. 22, 2016

(54) METHOD FOR TRANSMITTING DATA AND RANDOM ACCESS METHOD OF WIRELESS TERMINAL

(71) Applicant: ELECTRONICS AND TELECOMMUNICATIONS RESEARCH INSTITUTE, Daejeon (KR)

(72) Inventor: Sung-Min OH, Daejeon (KR)

(73) Assignee: ELECTRONICS AND TELECOMMUNICATIONS RESEARCH INSTITUTE, Daejeon (KR)

(21) Appl. No.: 15/189,027

(22) Filed: Jun. 22, 2016

(30) Foreign Application Priority Data
Jun. 22, 2015 (KR) 10-2015-0088676
Jun. 21, 2016 (KR) 10-2016-0077345

(51) Int. Cl. H04W 72/04; H04W 74/08

(52) U.S. Cl. CPC H04W 72/0413; H04W 74/0833

(57) ABSTRACT

A wireless terminal transmits stop state information to a base station upon an initial network access and receives resource pool information and transmission unit information for small data transmission in the wireless terminal from the base station. The wireless terminal selects a subframe index and a transmission unit index for data transmission from a resource pool for the small data transmission and transmits data in a transmission unit corresponding to the transmission unit index within a subframe corresponding to the subframe index.

### CROSS-REFERENCE TO RELATED APPLICATION

This application claims priority to and the benefit of Korean Patent Application No. 10-2015-0088676, and 10-2016-0077345 filed in the Korean Intellectual Property Office on Jun. 22, 2015, and Jun. 21, 2016, the entire contents of which are incorporated herein by reference.

### BACKGROUND OF THE INVENTION

(a) Field of the Invention

The present invention relates to a method for transmitting data and random access method of a wireless terminal, and more particularly, to a method for transmitting data of a wireless terminal capable of reducing a signaling overhead upon a control of the wireless terminal and an uplink data transmission of the wireless terminal.

(b) Description of the Related Art

Most of wireless terminals expected to be applied to services such as a smart meter, home automation, eHealth, and an environment sensing sensor have intermittently transmitted small data. However, the existing cellular communication system is appropriately designed for voice communication continuously transmitting data, web browsing, multimedia services, or the like when a session is once connected to a mobile terminal. As a result, a signaling overhead problem of the terminal intermittently transmitting the small data in a cellular communication system may occur as follows.

In the existing cellular communication system, periodic operations for controlling a mobile terminal are defined. For example, in the existing cellular communication system, if a tracking area update (TAU) timer expires, the corresponding terminal transmits a TAU request to a network to transmit its own location related information. Further, to provide inter-cell mobility, a procedure for measuring and reporting a signal between a serving cell and adjacent cells is defined. However, when the wireless terminal is in a stop state, periodic operations considering mobility may be unnecessary.

In addition to that, the existing cellular communication system is changed to an idle state if the terminal does not transmit data for a predetermined time (user inactivity timer). Here, the idle state means a radio resource control (RRC)-idle and an evolved packet system (EPS) connection management (ECM)-idle. In the idle state, a data radio bearer (DRB) and an S1 bearer are released on a user plane and an RRC connection and S1 signaling connection are released on a control plane.

When the existing cellular communication system intermittently transmits the small data, the wireless terminal is highly likely to transmit data in the idle state. Therefore, the wireless terminal involves an operation procedure for again setting a bearer and control connection which are released to transmit data. As a result, when a size of the data transmitted by the wireless terminals is as small as tens to hundreds of bytes, the operation procedure for transmitting data may be very inefficient.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for transmitting data and random access method of a wireless terminal having advantages of reducing a signaling overhead which may occur in a wireless terminal intermittently transmitting small data in a wireless communication system.

An exemplary embodiment of the present invention provides a method for transmitting data of a wireless terminal. The method for transmitting data of a wireless terminal, includes: transmitting stop state information to a base station upon an initial network access; receiving resource pool information and transmission unit information for small data transmission in the wireless terminal from the base station; selecting a subframe index and a transmission unit index for the data transmission from a resource pool for small data transmission; and transmitting data in a transmission unit corresponding to the transmission unit index within a subframe corresponding to the subframe index.

Another exemplary embodiment of the present invention provides a random access method of a wireless terminal. The random access method, includes: transmitting a random access preamble to a base station; receiving a random access response from the base station; transmitting a RRC Connection Request message to the base station; receiving a RRC Connection Setup message from the base station; and transmitting a RRC Connection Complete message to the base station, wherein the RRC Connection Request message includes at least one of C-RNTI, an establishment cause, and a buffer size, and wherein the buffer size indicates a data size of the RRC connection complete message.

### BRIEF DESCRIPTION OF THE DRAWINGS

FIG. 1 is a diagram illustrating an initial network access procedure of a wireless terminal according to an exemplary embodiment of the present invention.

FIG. 2 is a diagram illustrating a method for controlling a periodic location information change according to an exemplary embodiment of the present invention.

FIG. 3 is a diagram illustrating a method for controlling a periodic signal measurement report according to an exemplary embodiment of the present invention.

FIG. 4 is a diagram illustrating a data transmission procedure after a network initial access of a wireless terminal according to an exemplary embodiment of the present invention.

FIG. 5 is a diagram illustrating a method for transmitting, by a wireless terminal, data to a base station using a control message according to an exemplary embodiment of the present invention.

FIG. 6 is a diagram illustrating a method for directly transmitting, by a wireless terminal, data according to an exemplary embodiment of the present invention.

FIG. 7 is a diagram illustrating a resource pool and transmission unit for transmitting small data according to an exemplary embodiment of the present invention.

FIG. 8 is a diagram illustrating a data transmission information channel within a transmission unit for transmitting small data according to an exemplary embodiment of the present invention.

FIG. 9 is a diagram illustrating a method for retransmitting, by a wireless terminal, random access-based MAC PDU according to an exemplary embodiment of the present invention.

FIG. 10 is a diagram illustrating a method for retransmitting, by a wireless terminal, uplink scheduling-based MAC PDU according to an exemplary embodiment of the present invention.

FIG. 11 is a diagram illustrating an apparatus for transmitting data according to an exemplary embodiment of the present invention.

FIG. 12 is a diagram illustrating an apparatus for controlling a wireless terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like

Further, the base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femto BS), a home node B (HNB), a home eNodeB (HeNB), a pico base station (pico BS), a metro base station (metro BS), a micro base station (micro BS), and the like), and the like and may also include all or some of the functions of the ABS, the HR-BS, the node B, the eNodeB, the AP, the RAS, the BTS, the MMR-BS, the RS, the RN, the ARS, the HR-RS, the small base stations, and the like.

Hereinafter, a method for transmitting data and random access method of a wireless terminal according to an exemplary embodiment of the present invention will be described in detail with reference to the accompanying drawings.

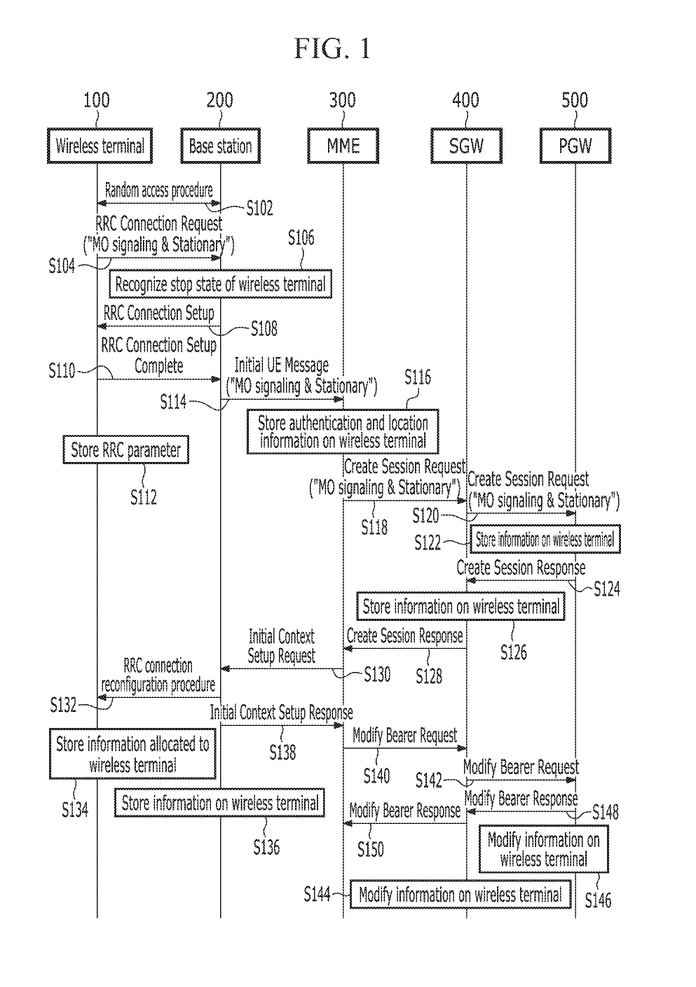

FIG. 1 is a diagram illustrating an initial network access procedure of a wireless terminal according to an exemplary embodiment of the present invention.

Referring to FIG. 1, a wireless terminal 100 performs a random access procedure to search for a base station 200 (S102).

The wireless terminal 100 transmits status information of the wireless terminal 100 to the base station 200, upon an initial network access. The wireless terminal 100 may periodically monitor its own location based on information provided from a cellular communication system or information provided from a location recognition system like a global positioning system (GPS) and may determine that the wireless terminal 100 is in a stop state if the location of the wireless terminal 100 is fixed for a predetermined time. When the wireless terminal 100 is a machine type communication (MTC) device, mobility may be determined depending on application services of the wireless terminal 100. For example, the MTC devices for services such a smarter meter and home automation may be in a stop state. The MTC devices for the application services may be set by a user to be in the stop state or transmit related parameters to a lower layer in an application layer to be in the stop state.

If the wireless terminal 100 is in the stop state, a radio resource control (RRC) connection procedure is performed when there is a need to set the RRC connection. The wireless terminal 100 sets an establishment cause among information elements (IEs) of an RRC connection request message as “mobile-originated (MO) signaling & stationary” and transmits the “MO signaling & stationary” to the base station 200 (S104). The MO signaling indicates an access cause for an uplink control signal transmission of the wireless terminal 100. Further, the “MO Signaling & Stationary” indicates the access cause for the uplink control signal transmission of the wireless terminal 100 which is in the stop state.

The base station 200 receiving the RRC connection request message set as the “MO Signaling & Stationary” recognizes that the wireless terminal 100 is in the stop state (S106). The base station 200 transmits an RRC connection setup message to the wireless terminal 100 (S108).

The wireless terminal 100 transmits an RRC connection setup complete message to the base station 200 (S110).

By doing so, if the RRC connection process between the wireless terminal 100 and the base station 200 is completed, the wireless terminal 100 stores RRC parameter values (S112) and the base station 200 generates an initial UE message and transmits the generated initial UE message to mobility management entity (MME) 300 (S114). In this case, the base station 200 sets an RRC establishment cause of the initial UE message as the “MO Signaling & Stationary” and transmits the “MO Signaling & Stationary” to the MME 300.

The MME 300 receiving the initial UE message set as the “MO Signaling & Stationary” performs an authentication and location registration process for the wireless terminal 100 and stores authentication and location information on the wireless terminal 100 (S116). The MME 300 adds a new establishment cause to a create session request message and sets the establishment cause of the create session request message as the “MO Signaling & Stationary” and transmits the “MO Signaling & Stationary” to an SGW 400 (S118). That is, the IE within the create session request message may include international mobile subscriber identity (IMSI), an EPS bearer ID, PGW-IP, an access point name (APN), a subscriber quality of service (QoS), profile (subscribed QoS profile), an EUTRAN cell global ID (ECGI), tracking area identity (TAI), the establishment cause, or the like. A subscriber profile may include a QoS class identifier (QCI), allocation and retention priority (ARP), an aggregate maximum bit rate (AMBR) (UL/DL), or the like.

The SGW 400 receiving the create session request message set as the “MO Signaling & Stationary” transmits the create session request message to a PGW 500 (S120).

Next, the PGW 500 sets the related parameters such as IP allocation and QoS profile to the wireless terminal 100 and transmits the create session response message to the SGW 400 (S124). In this case, the PGW 500 stores the terminal IP, the evolved packet system (EPS) bearer ID, a tunnel ID (TEID), the QoS profile, or the like for the wireless terminal 100 (S122). The EPS bearer indicates a logical path generated in a {wireless terminal 100-base station 200-SGW 400-PGW 500} section.

If the SGW 400 receives the create session response message, the SGW 400 stores the information on the wireless terminal 100 (S126) and then transmits the create session response message to the MME 300 (S128).

The MME 300 transmits an initial context setup request message to the base station 200 (S130).

The base station 200 performs security setup and data radio bearer (DRB) setup to the wireless terminal 100 using an RRC connection reconfiguration procedure with the wireless terminal 100 (S132). In this case, the wireless terminal 100 stores parameters allocated to the wireless terminal 100 (S134) and the base station 200 also stores parameters for the wireless terminal 100 (S136).

If the DRB setup is completed, the wireless terminal 100 calculates and stores an uplink modulation and coding scheme (MCS) level based on channel information with the base station 200.

The base station 200 transmits an initial context setup response message to the MME 300 (S138).

The MME 300 transmits a modify bearer request message to the SGW (S140).

The SGW 400 transmits the modify bearer request message to the PGW 500 (S142) and modifies information on the wireless terminal 100 (S144). The PGW 500 receiving the modify bearer request message modifies the information on the wireless terminal 100 (S146).

The PGW 500 transmits the modify bearer response message to the SGW 400 (S148) and the SGW 400 transmits the modify bearer response message to the MME 300 (S150).

If the initial access procedure is performed, the base station 200, the MME 300, the SGW 400, and the PGW 500 may recognize that the wireless terminal 100 transmits data in the stop state. Therefore, the base station 200, the MME 300, the SGW 400, and the PGW 500 continuously maintain the information on the wireless terminal 100 without deleting the information even when the wireless terminal 100 is changed to the idle state. However, when the RRC connection and the DRB setup need to be released due to a lack of radio section resources in the idle state, like a cell radio network temporary identifier (C-RNTI) and an MCS for the wireless terminal 100, the RRC connection and DRB setup parameter values other than parameters required to transmit data may be deleted.

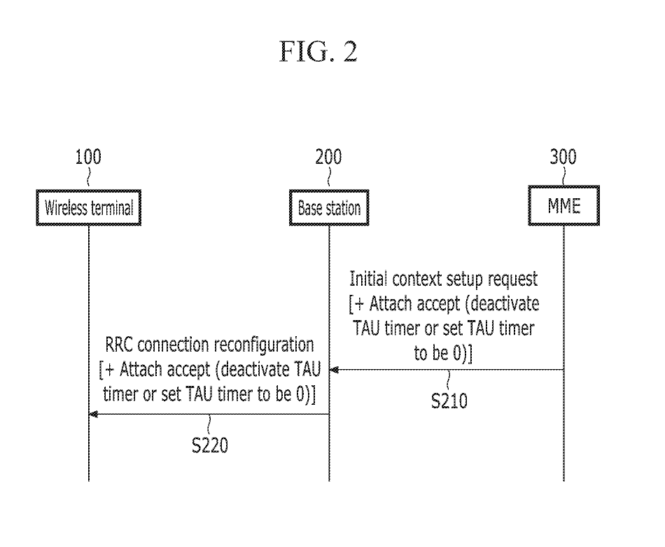

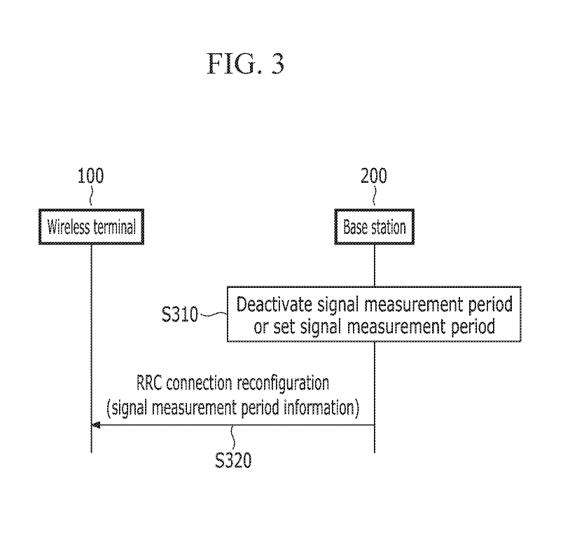

Further, since the network may recognize that the wireless terminal 100 is in the stop state, the mobility related operations performed in the existing cellular communication system may be more efficiently controlled. Here, an exemplary embodiment for the periodic operation is as illustrated in FIGS. 2 and 3. However, in addition to the exemplary embodiments illustrated in FIGS. 2 and 3, it is possible to efficiently control the periodic operation procedure associated with the mobility of the wireless terminal 100.

FIG. 2 is a diagram illustrating a method for controlling a periodic location information change according to an exemplary embodiment of the present invention.

Referring to FIG. 2, if the wireless terminal 100 is in the stop state, the MME 300 may deactivate a tracking area update (TAU) timer within an attach accept message or sets the TAU timer to be “0” and transmit the TAU timer to the wireless terminal 100 or may set the TAU timer to be a value larger than the existing value and transmit the TAU timer to the wireless terminal 100 (S210).

The attach accept message generated in the MME 300 is transmitted to the base station 200, while being included in the initial context setup request message.

The base station 200 transmits the attach accept message within the RRC connection reconfiguration message to the wireless terminal 100 (S220).

The wireless terminal 100 receiving the RRC connection reconfiguration message including the attach accept message may not transmit a TAU request message or may transmit the TAU request message at a longer period.

FIG. 3 is a diagram illustrating a method for controlling a periodic signal measurement report according to an exemplary embodiment of the present invention.

Referring to FIG. 3, the base station 200 may deactivate a periodic signal measurement or set a signal measurement period to be a longer value if the wireless terminal 100 is in the stop state (S310).

The base station 200 may transmit signal measurement setup information including signal measurement period information to the wireless terminal 100 through the RRC connection reconfiguration message (S320).

To deactivate the periodic signal measurement, the base station 200 may transmit the RRC connection reconfiguration message while deleting and removing the signal measurement setup information on the wireless terminal 100 from the RRC connection reconfiguration message. The wireless terminal 100 may deactivate a signal measuring function if no signal measurement setup information is present.

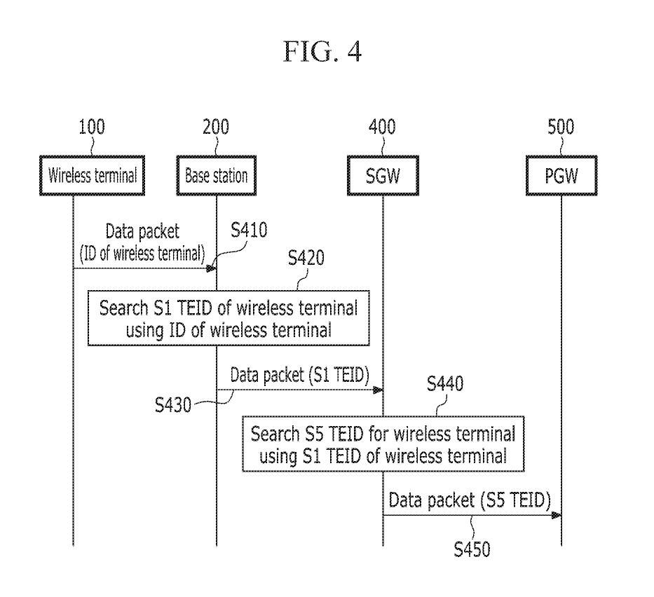

FIG. 4 is a diagram illustrating a data transmission procedure after a network initial access of a wireless terminal according to an exemplary embodiment of the present invention.

Referring to FIG. 4, the bearer and control setup related information on the wireless terminal 100 which is in the stop state is stored in the wireless terminal 100 and the network upon the initial network access. Therefore, the wireless terminal 100 may transmit a data packet to the base station 200 (S410). In this case, the wireless terminal 100 transmits the data packet to which a terminal identifier (ID) is added.

The base station 200 receiving data may search for an S1 TEID allocated to the wireless terminal 100 using the ID of the wireless terminal 100 (S420) and transmit the data packet of which the header is added with the S1 TEID to the SGW 400 through an S1 bearer (S430).

The SGW 400 searches for an S5 TEID for the wireless terminal 100 using the S1 TEID included in the header of the received data packet (S440) and transmits the data packet of which the header is added with the S5 TEID to the PGW 500 (S450).

By the method, the wireless terminal 100 which is in the stop state may transmit data to the network.

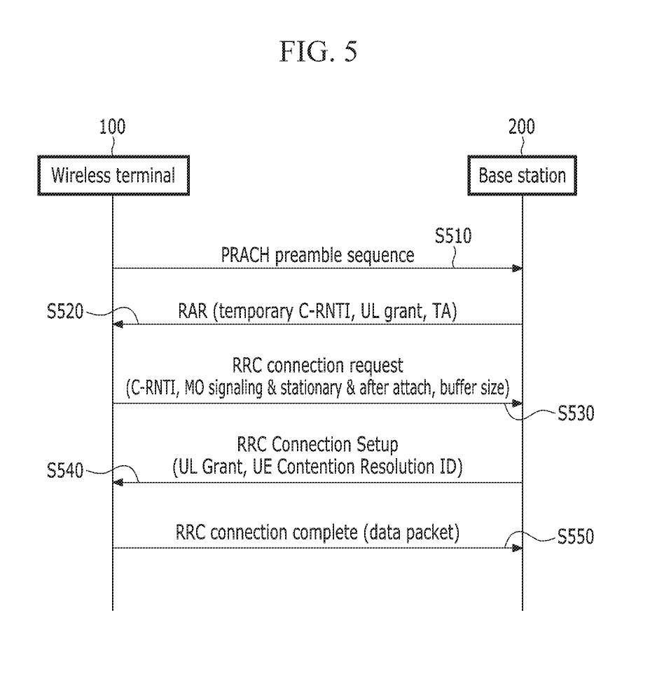

FIG. 5 is a diagram illustrating a method for transmitting, by a wireless terminal, data to a base station using a control message according to an exemplary embodiment of the present invention.

Referring to FIG. 5, if data to be transmitted are generated, the wireless terminal 100 randomly selects one of preamble indexes and transmits a physical random access channel (PRACH) preamble sequence corresponding to the selected preamble index to the base station 200 (S510).

The base station 200 receiving the PRACH preamble sequence transmits a random access response (RAR) massage in which a temporary C-RNTI, an uplink grant (UL grant), and timing alignment (TA) information are included to the wireless terminal 100 (S520).

The wireless terminal 100 receiving the RAR message transmits the RRC connection request message to the base station 200 through an allocated resource within the uplink grant (S530). In this case, the RRC connection request message includes the C-RNTI, the establishment cause, a buffer size, or the like which are stored in the wireless terminal 100. Here, the wireless terminal 100 sets the establishment cause within the RRC connection request message as “MO Signaling & Stationary & After Attach” to inform the base station 200 that the wireless terminal 100 stores the bearer and control setup related information upon the initial access. Further, the buffer size includes a size of the RRC connection complete message including the data packet that the wireless terminal 100 will transmit later.

The base station 200 generates the RRC connection setup message and transmits the generated RRC connection setup message to the wireless terminal 100 (S540). In this case, the base station 200 may transmit the uplink grant (UL grant) and a UE contention resolution ID to the wireless terminal 100 through a medium access control (MAC) control element (CE) of the RRC connection setup message. The base station 200 allocates an uplink resource for transmitting, by the wireless terminal 100, the RRC connection complete message based on the buffer size and the UL grant includes resource allocation information for transmitting the RRC connection complete message. Here, the UL grant may also be transmitted to the wireless terminal 100 through a physical downlink control channel (PDCCH), not through the MAC CE.

The wireless terminal 100 includes the data packet in the RRC connection complete message and transmits the RRC connection complete message to the base station 200 through the uplink resource allocated through the UL grant (S550).

By doing so, the wireless terminal 100 may use the RRC message to transmit data to the base station 200.

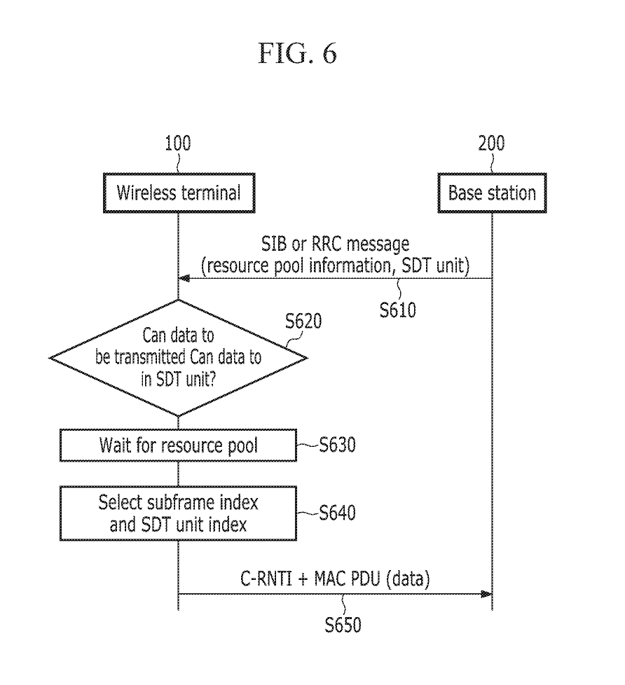

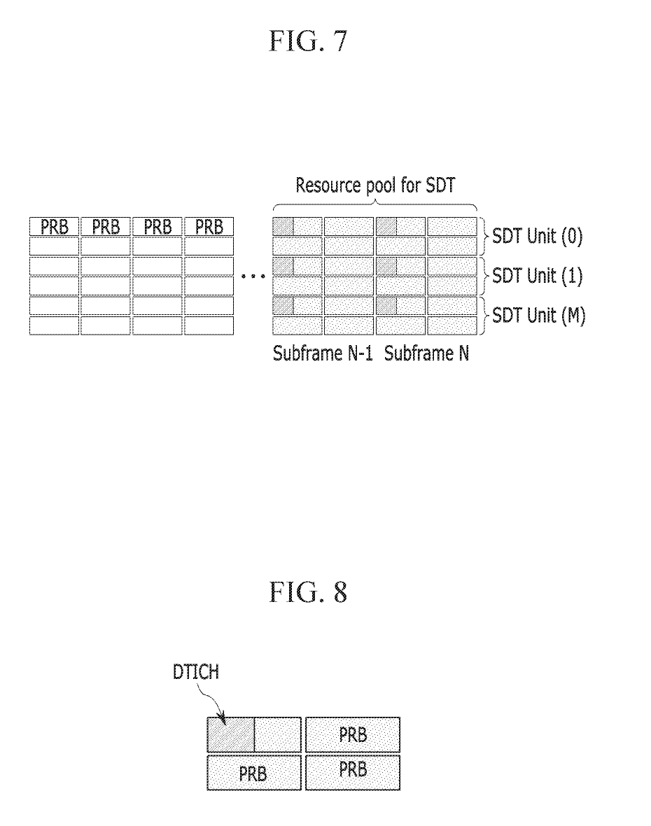

FIG. 6 is a diagram illustrating a method for directly transmitting, by a wireless terminal, data according to an exemplary embodiment of the present invention and FIG. 7 is a diagram illustrating a resource pool and transmission unit for transmitting small data according to an exemplary embodiment of the present invention. Further, FIG. 8 is a diagram illustrating a data transmission information channel within a transmission unit for transmitting small data according to an exemplary embodiment of the present invention.

Referring to FIG. 6, the base station 200 may transmit the parameters associated with the data transmission to the wireless terminal 100 through a system information block (SIB) or the RRC message upon the initial access to directly transmit data (S610). Here, the parameters associated with the data transmission may include resource pool information for small data transmission (SDT), SDT unit information, ID to be used upon the data transmission, or the like. The resource pool for the SDT and SDT unit may be defined as illustrated in FIG. 7. That is, the resource pool may be configured in a subframe unit and the SDT unit may be configured in a physical resource block (PRB) unit or a PRB group unit within the subframe. Each SDT unit [SDT unit (0), SDT unit (1), . . . SDT unit(M)] may be differentiated by SDT indexes (0, 1, . . . , M).

Further, as illustrated in FIG. 8, a data transmission information channel (DTICH) which may transfer data transmission related information may be allocated within the SDT unit. The DTICH may include information required to transmit data such as the C-RNTI, the MCS level, and a transport block size. Here, the DTICH may be scrambled based on the C-RNTI, but an identifier which may be known by the base station 200 like a physical cell identifier (physical cell ID) instead of the C-RNTI may be used. Further, as the MCS level, the wireless terminal 100 may use a value calculated based on the channel information with the base station 200 upon the initial access. The SDT unit may be calculated based on a packet size reference and a transmission format, in which the transmission format may be fixedly or semi-fixedly used without being dynamically changed.

The wireless terminal 100 determines whether the size of the data packet to be transmitted may be transmitted in the SDT unit (S620). If transmittable, data are mapped to a signaling radio bearer (SRB) or the stored DRB in the RRC layer.

Next, the wireless terminal 100 stores the corresponding data in a buffer which is in an uplink-shared channel (UL-SCH) of a transport channel.

The wireless terminal 100 waits for the resource pool for the SDT (S630) and randomly selects a subframe index and an SDT unit index to be transmitted in the resource pool section for the SDT (S640).

The wireless terminal 100 transmits the C-RNTI and an MAC protocol data unit (MAC PDU) (data) to the base station 200 in the SDT unit within the selected subframe (S650). Here, the C-RNTI may be transmitted through the DTICH and may also be transmitted through the C-RNTI MAC CE which is defined within the MAC PDU.

Further, the wireless terminal 100 stores a copy of the MAC PDU in a hybrid automatic repeat request (HARQ) buffer when transmitting the MAC PDU and starts a timer for the corresponding MAC PDU. Next, when the transmitted MAC PDU needs to be retransmitted due to a collision or a transmission error, the MAC PDU may be retransmitted according to the retransmission method.

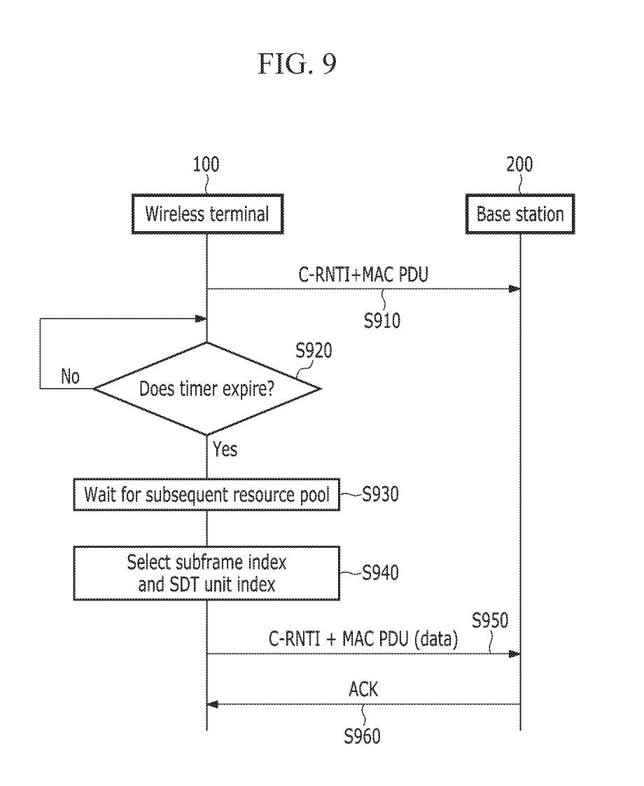

FIG. 9 is a diagram illustrating a method for retransmitting, by a wireless terminal, random access-based MAC PDU according to an exemplary embodiment of the present invention.

Referring to FIG. 9, when the decoding is impossible in the base station 200 due to the collision or the transmission error of the MAC PDU and the C-RNTI which are transmitted by the wireless terminal 100, the base station 200 may not transmit NACK because it does not know which of the wireless terminals 100 transmits the MAC PDU and the C-RNTI. Therefore, the wireless terminal 100 transmits the MAC PDU and the C-RNTI (S910) and then drives the timer.

The wireless terminal 100 checks whether the timer expires (S920). If the wireless terminal 100 does not receive ACK for the MAC PDU from the base station 200 until the timer expires, the wireless terminal 100 retransmits the MAC PDU which is in the HARQ retransmission buffer.

The wireless terminal 100 waits for the next resource pool for the SDT to retransmit the MAC PDU (S930). The wireless terminal 100 randomly selects the subframe index and the SDT unit index (S940) and retransmits the C-RNTI and the MAC PDU (data) to the base station 200 in the SDT unit within the selected subframe (S950).

The wireless terminal 100 may retransmit the MAC PDU up to the maximum retransmission frequency by the foregoing method and if the retransmission frequency is equal to or more than the maximum retransmission frequency, deletes the corresponding MAC PDU from the HARQ retransmission buffer.

If the wireless terminal 100 receives the ACK from the base station 200 within the maximum retransmission frequency (S960), the wireless terminal 100 finishes the HARQ retransmission operation.

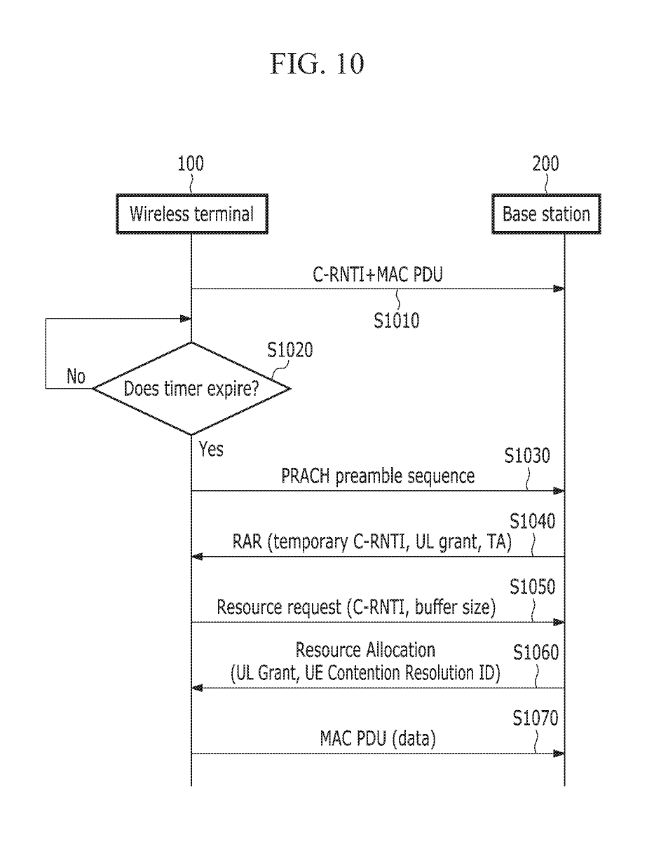

FIG. 10 is a diagram illustrating a method for retransmitting, by a wireless terminal, uplink scheduling-based MAC PDU according to an exemplary embodiment of the present invention.

Referring to FIG. 10, the wireless terminal 100 transmits the MAC PDU and then checks whether the timer expires (S1010 and S1020).

If the wireless terminal 100 does not receive the ACK until the timer expires, the wireless terminal 100 determines the retransmission of the MAC PDU which is in the HARQ retransmission buffer.

If the retransmission of the MAC PDU is determined, the wireless terminal 100 waits for a subsequent PRACH subframe. Here, the wireless terminal 100 may wait for the subsequent PRACH subframe in the first retransmission or may perform the retransmission of the MAC PDU as much as any frequency and then wait for the PRACH subframe.

The wireless terminal 100 randomly selects the preamble index in the PRACH subframe and transmits the PRACH preamble sequence corresponding to the selected preamble index to the base station 200 (S1030).

The base station 200 transmits the RAR message for the PRACH preamble sequence to the wireless terminal 100 (S1040). In this case, the RAR message includes the temporary C-RNTI, the UL grant, and the TA information.

The wireless terminal 100 transmits the resource request message to the base station 200 through the uplink resource allocated within the UL grant (S1050). Here, the resource request message may include the C-RNTI, the buffer size, or the like. The buffer size is determined based on the size of the MAC PDU which is in the HARQ retransmission buffer.

The base station 200 transmits the resource allocation message including the UL grant and the UE contention resolution ID to the wireless terminal 100 (S1060).

The wireless terminal 100 retransmits the MAC PDU to the base station 200 through the uplink resource allocated through the UL grant. In this case, the wireless terminal 100 transmits the MAC PDU which is in the HARQ retransmission buffer (S1070).

The wireless terminal 100 may retransmit the MAC PDU up to the maximum retransmission frequency by the foregoing method and if the retransmission frequency is equal to or more than the maximum retransmission frequency, deletes the corresponding MAC PDU from the HARQ retransmission buffer.

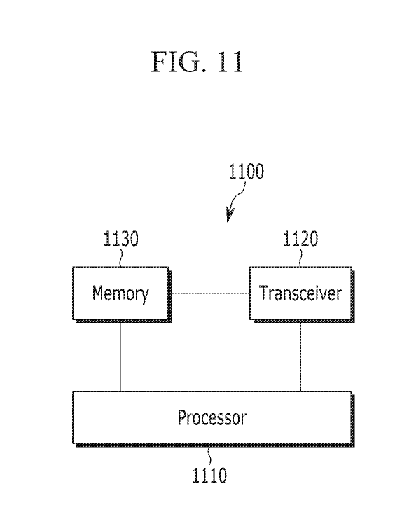

FIG. 11 is a diagram illustrating an apparatus for transmitting data according to an exemplary embodiment of the present invention.

Referring to FIG. 11, an apparatus 1100 for transmitting data includes a processor 1110, a transceiver 1120, and a memory 1130. The apparatus 1100 for transmitting data may be included in the wireless terminal 100.

The processor 1110 may be implemented to perform the function of the wireless terminal 100 described with reference to FIGS. 1 to 10.

The transceiver 1120 is connected to the processor 1110 to transmit and receive a wireless signal to and from the base station 200.

The memory 1130 stores instructions which are performed by the processor 1110 or loads instructions from a storage device (not illustrated) and temporarily stores the instructions and the processor 1110 may execute the instructions which are stored or loaded in the memory 1130. Further, the memory 1130 may store information required to allow the processor 1110 to perform the function of the wireless terminal 100 described with reference to FIGS. 1 to 10.

The processor 1110 and the memory 1130 are connected to each other through a bus (not illustrated) and an input/output interface (not illustrated) may also be connected to the bus. In this case, the transceiver 1120 is connected to the input/output interface and peripheral devices such as an input device, a display, a speaker, and a storage device may be connected to the input/output interface.

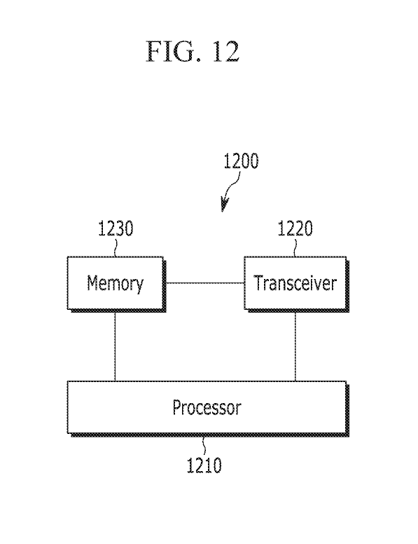

FIG. 12 is a diagram illustrating an apparatus for controlling a wireless terminal according to an exemplary embodiment of the present invention.

Referring to FIG. 12, an apparatus 1200 for controlling a wireless terminal includes a processor 1210, a transceiver 1220, and a memory 1230. The apparatus 1200 for controlling a wireless terminal may be implemented within the base station 200.

The processor 1210 may be implemented to perform the function of the base station 200 described with reference to FIGS. 1 to 10.

The transceiver 1220 is connected to the processor 1210 to transmit and receive a wireless signal to and from the wireless terminal 100.

The memory 1230 stores instructions which are performed by the processor 1210 or loads instructions from a storage device (not illustrated) and temporarily stores the instructions and the processor 1210 may execute the instructions which are stored or loaded in the memory 1230. Further, the memory 1230 may store information required to allow the processor 1210 to perform the function of the base station 200 described with reference to FIGS. 1 to 10.

The processor 1210 and the memory 1230 are connected to each other through a bus (not illustrated) and an input/output interface (not illustrated) may also be connected to the bus. In this case, the transceiver 1220 is connected to the input/output interface and peripheral devices such as an input device, a display, a speaker, and a storage device may be connected to the input/output interface.

According to an embodiment of the present invention, the signaling overhead which may occur when the wireless terminals in the existing cellular system intermittently transmit data may be reduced. In detail, the periodic signaling procedure for providing mobility to the wireless terminals in the stop state may be omitted or simplified and the bearer and connection setup procedure which may occur when the wireless terminal transmits data in the idle state after the initial access to transmit the data may be simplified, thereby reducing the signaling overhead.

Further, the data may be transmitted in the transmission unit set to transmit the small data when the data are directly transmitted to reduce the collision probability due to the direct transmission of data, and the data may be retransmitted to the uplink resource allocated through the uplink scheduling based retransmission method to solve the throughput performance degradation phenomenon of the physical uplink shared channel (PUSCH) due to the excessive retransmission of data.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting data of a wireless terminal, comprising:
transmitting stop state information to a base station upon an initial network access;
receiving resource pool information and transmission unit information for small data transmission in the wireless terminal from the base station;
selecting a subframe index and a transmission unit index for data transmission from a resource pool for the small data transmission; and
transmitting data in a transmission unit corresponding to the transmission unit index within a subframe corresponding to the subframe index.

2. A random access method of a wireless terminal, comprising:
transmitting a random access preamble to a base station;
receiving a random access response from the base station;
transmitting a RRC Connection Request message to the base station;
receiving a RRC Connection Setup message from the base station; and
transmitting a RRC Connection Complete message to the base station,
wherein the RRC Connection Request message includes at least one of C-RNTI, an establishment cause, and a buffer size, and
wherein the buffer size indicates a data size of the RRC connection complete message.
